(19) United States
(12) Patent Application Publication
(10) Pub. No.: US 2022/0282089 A1
(43) Pub. Date: Sep. 8, 2022

(54) RESIN COMPOSITION AND FILM

(71) Applicant: KANEKA CORPORATION, Osaka (JP)

(72) Inventors: Takashi Ando, Osaka (JP); Kohei Ogawa, Osaka (JP); Masahiro Miyamoto, Osaka (JP)

(73) Assignee: KANEKA CORPORATION, Osaka (JP)

(21) Appl. No.: 17/751,985

(22) Filed: May 24, 2022

Related U.S. Application Data
(63) Continuation of application No. PCT/JP2020/048036, filed on Dec. 22, 2020.

(30) Foreign Application Priority Data
Dec. 24, 2019 (JP) 2019-232976
Jan. 30, 2020 (JP) 2020-014037

(51) Int. Cl. C08L 79/08; C08L 69/00; C08L 67/03

(52) U.S. Cl. CPC C08L 79/08; C08L 69/00; C08L 67/03

(57) ABSTRACT

A resin composition contains a polyimide resin and an ester-based resin. The ester-based resin is polycarbonate or polyarylate. The polyimide contains a structural unit represented by general formula (1). In general formula (1), X is a divalent organic group shown in group (I), and Y is a divalent group that contains one or more selected from the group consisting of a fluorine group, a trifluoromethyl group, a sulfonic group, a fluorene structure and an alicyclic structure. Each of R¹ and R² is a fluorine atom, an alkyl group having 1 to 20 carbon atoms, or a fluoroalkyl group having 1 to 20 carbon atoms, m is an integer of 1 to 4, and n is an integer of 0 to 4.

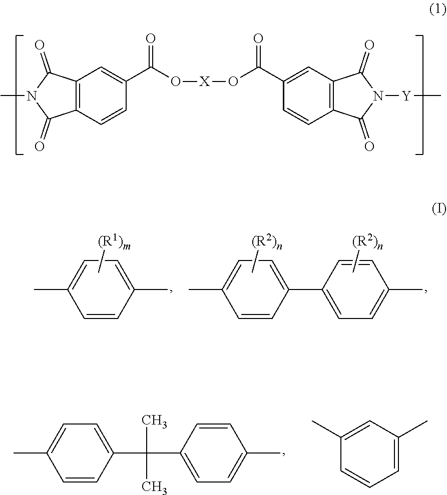

### TECHNICAL FIELD

One or more embodiments of the present invention relate to a resin composition and a film.

### BACKGROUND

Electronics devices such as display devices such as liquid crystal displays, organic EL displays and electronic papers, solar cells, and touch panels are required to be thin, lightweight and flexible. Glass materials that are used for these devices are replaced by film materials to make the devices flexible, thin and lightweight. As a replacement for glass, a transparent polyimide film has been developed and used for substrates for displays, cover films and the like.

A general polyimide film is obtained by applying a polyamic acid solution, which is a polyimide precursor, onto a support in the form of a film, and subjecting the film to high-temperature treatment to remove a solvent and perform thermal imidization. However, the heating temperature for thermal imidization is high (e.g. 300° C. or higher), and coloring (increased yellowness) by heating is likely to occur, so that use for products required to have high transparency, such as cover films for displays, is difficult. Patent Documents 1 to 3 disclose a polyimide resin which is soluble in an organic solvent, and does not require imidization at a high temperature after being formed into a film.

A polyimide film is obtained by dissolving the soluble polyimide such as disclosed in Patent Documents 1 to 3 into an organic solvent, applying onto a support, and removing the organic solvent. A film produced by a solution casting method has small birefringence in general. However, in a polyimide, due to its molecular structure, molecules are apt to orient in-plane, and the film has large birefringence in a thickness direction even when produced by a solution casting method, so that iridescent unevenness and a shift in color tone are observed when viewed from an oblique direction.

Patent Document 4 indicates that a polyimide with alicyclic tetracarboxylic dianhydride as a raw material can have both transparency and low birefringence. However, the molecular weight of polyimide with alicyclic tetracarboxylic dianhydride as a raw material is unlikely to increase during polymerization, so it is difficult to produce a film having high mechanical strength.

### PATENT DOCUMENTS

Patent Document 1: Japanese Patent Laid-Open Publication No. 2012-144603

Patent Document 2: Japanese Patent Laid-Open Publication No. 2016-132686

Patent Document 3: International Publication No. WO 2017/175869

Patent Document 4: Japanese Patent No. 6174580

### SUMMARY

In a polyimide, introduction of a rigid structure improves mechanical strength, but causes a decrease in solubility in an organic solvent and transparency and an increase in birefringence, and it is not easy for a conventional transparent polyimide resin to have both low birefringence and high mechanical strength while maintaining transparency. One or more embodiments of the present invention are to provide a transparent film having low birefringence and sufficient mechanical strength, and a resin composition which is used for production of the transparent film.

The present inventors have found that a polyimide having a specific chemical structure and a specific ester-based resin are compatible with each other, and a film having high transparency can be produced from a resin composition obtained by mixing the polyimide and the ester-based resin.

### DETAILED DESCRIPTION

An aspect of one or more embodiments of the present invention relates to a film and a resin composition each containing a polyimide resin and an ester-based resin. The resin composition may contain a polyimide resin and an ester-based resin at a weight ratio of 98:2 to 2:98.

The polyimide contains a structural unit of general formula (1).

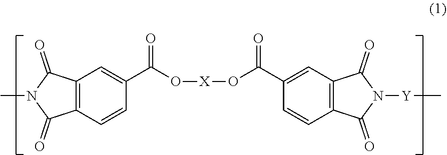

The structural unit of general formula (1) is obtained by a reaction of an acid dianhydride of general formula (3) and a diamine of general formula (4).

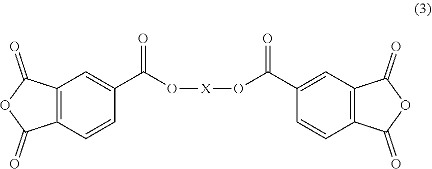

H₂N—Y—N H₂ (4)

X in general formulae (1) and (3) is a divalent organic group of group (I).

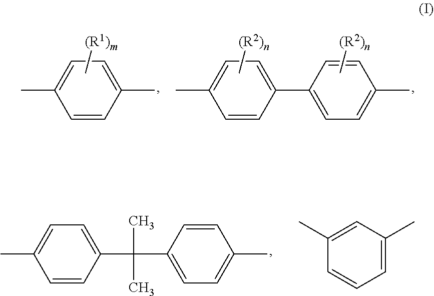

Each of R¹ and R² is a fluorine atom, an alkyl group having 1 to 20 carbon atoms, or a fluoroalkyl group having 1 to 20 carbon atoms, m is an integer of 1 to 4, and n is an integer of 0 to 4.

Y in general formulae (1) and (4) is a divalent group containing one or more selected from the group consisting of a fluorine group, a trifluoromethyl group, a sulfone group, a fluorene structure and an alicyclic structure.

The ratio of the tetracarboxylic dianhydride of general formula (3) to the total amount of the acid dianhydride components of the polyimide may be 30 mol % or more, 40 mol % or more, 45 mol % or more or 50 mol % or more, and may be 90 mol % or less.

The acid dianhydride components of the polyimide may include an acid dianhydride of formula (6) as the acid dianhydride of general formula (3). The polyimide may contain the acid dianhydride of formula (6) at 30 mol % or more, 40 mol % or more, 45 mol % or more, or 50 mol % or more based on the total amount of the acid dianhydride components.

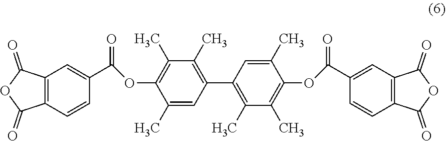

The polyimide resin may be soluble in methylene chloride. The solubility parameter (SP value) of the polyimide may be 8.10 to 9.10 (cal/cm³)^{1/2}. The solubility parameter of the polyimide is obtained by summing the products of the solubility parameters and the molar ratios of diamines and acid dianhydrides that form the polyimide.

The ester-based resin is polycarbonate or polyarylate. The polycarbonate may contain a repeating unit of formula (8), and the polyarylate may contain a repeating unit of formula (10).

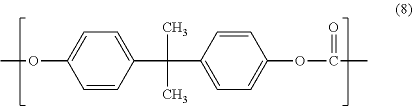

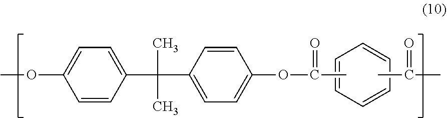

The film according to one or more embodiments of the present invention has a thickness of 5 μm or more and 300 μm or less, a haze of 3.5% or less, an YI of 5.0 or less, a thickness retardation Rth of 3000 nm or less, and a tensile modulus of 3.0 GPa or more.

Since a polyimide resin and an ester-based resin contained in a resin composition are compatible with each other, a transparent film having a small haze is obtained. In addition, since the polyimide resin and the ester-based resin are compatible with each other, birefringence can be reduced without significantly deteriorating the excellent mechanical strength of the polyimide, and therefore a transparent film suitable for cover films of displays, etc. can be produced.

### Resin Composition

One or more embodiments of the present invention are a compatible resin composition containing a polyimide resin and an ester-based resin. The polyimide contains a structural unit of the following general formula (1), and the ester-based polymer contains a structural unit of general formula (2).

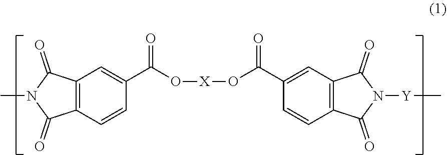

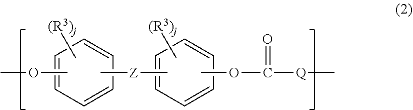

In general formula (1), Y is a diamine residue having one or more selected from the group consisting of a fluorine group, a trifluoromethyl group, a sulfone group, a fluorene structure and an alicyclic structure. X is a divalent organic group selected from the following group (I).

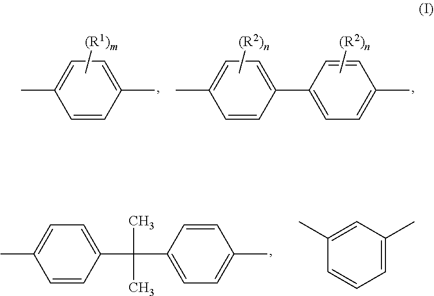

Each of R¹ and R² in group (I) is a fluorine atom, an alkyl group having 1 to 20 carbon atoms, or a fluoroalkyl group having 1 to 20 carbon atoms, m is an integer of 1 to 4, and n is an integer of 0 to 4.

In general formula (2), Z is any divalent organic group, R³ is a halogen, an alkyl group having 1 to 20 carbon atoms, or a halogenated alkyl group having 1 to 20 carbon atoms, and j is an integer of 0 to 4. Q is a direct bond, or a divalent organic group selected from the following group (II).

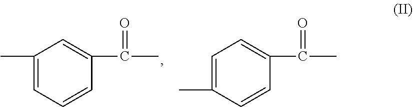

When Q is a direct bond, the polymer having a repeating unit of general formula (2) is polycarbonate. When Q is a divalent organic group selected from group (II), the polymer having repeat units of general formula (2) is a polyarylate.

The polycarbonate is a carbonic acid ester of bisphenol, polyarylate is an ester of bisphenol and phthalic acid, and the former and the latter are alike in that both are esters of bisphenol. Hereinafter, the polycarbonate and the polyarylate are collectively referred to as an “ester-based polymer”, and the polycarbonate resin and the polyarylate resin are collectively referred to as an “ester-based resin”.

### Polyimide Resin

The polyimide in the present embodiment contains a structural unit of the above general formula (1). The polyimide is obtained by dehydrating and cyclizing a polyamic acid obtained by condensation of a tetracarboxylic acid dianhydride (hereinafter, sometimes referred to as an “acid dianhydride”) with a diamine. In other words, the polyimide has an acid dianhydride-derived structure (acid dianhydride component) and a diamine-derived structure (diamine component).

### Acid Dianhydride

The polyimide in the present embodiment contains a bis(trimellitic anhydride) ester of the following general formula (3) as an acid dianhydride component.

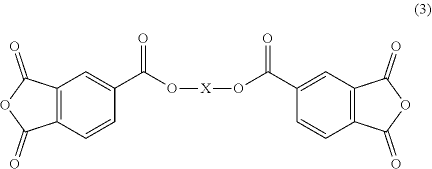

X in general formula (3) is identical to X in general formula (1). That is, X is one of the following (IA), (IB), (IC) and (ID).

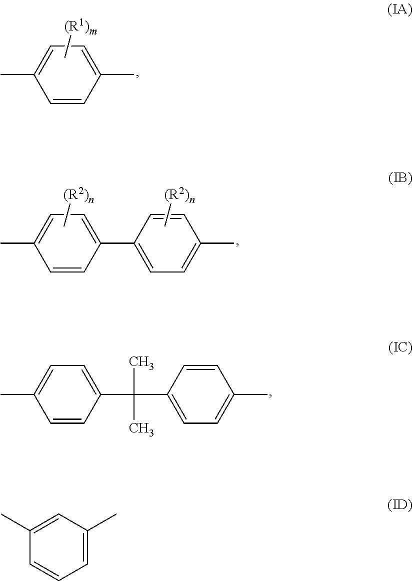

R¹ in formula (IA) is a fluorine atom, an alkyl group having 1 to 20 carbon atoms, or a fluoroalkyl group having 1 to 20 carbon atoms, and m is an integer of 1 to 4. The group of formula (1A) is a group obtained by removing two hydroxyl groups from a hydroquinone derivative having a substituent on a benzene ring. Examples of the hydroquinone having a substituent on a benzene ring include tert-butylhydroquinone, 2,5-di-tert-butylhydroquinone and 2,5-di-tert-amylhydroquinone.

R² in formula (IB) is a fluorine atom, an alkyl group having 1 to 20 carbon atoms, or a fluoroalkyl group having 1 to 20 carbon atoms, and n is an integer of 0 to 4. The group of formula (IB) is a group obtained by removing two hydroxyl groups from biphenol optionally having a substituent on a benzene ring. Examples of the biphenol derivative having a substituent on a benzene ring include 2,2′-dimethylbiphenyl-4,4′-diol, 3,3′-dimethylbiphenyl-4,4′-diol, 3,3′,5,5′-tetramethylbiphenyl-4,4′-diol and 2,2′,3,3′,5,5′-hexamethylbiphenyl-4,4′-diol.

The group of formula (IC) is a group obtained by removing two hydroxyl groups from 4,4′-isopropylidenediphenol (bisphenol A). The group of formula (1D) is a group obtained by removing two hydroxyl groups from resorcinol.

From the viewpoint of compatibility with the ester-based resin, X may be (IB), (IC) or (ID), or (IB), among the above-described groups. In particular, X may be a group in which n is 3 and substituents are present at the positions 2,2 ′, 3, 3′, 5 and 5′ on biphenyl. When substituents are present at these positions, a bond between benzene rings of a biphenyl backbone is twisted due to steric hindrance of the substituent, or the like, so that the solubility of the polyimide in an organic solvent is improved, and compatibility with the ester-based resin tends to be enhanced.

Specific examples of the divalent-value organic group which is represented by formula (IB) and has a substituent at the positions 2, 2′, 3, 3′, 5 and 5′ on biphenyl include 2,2′,3,3′,5,5′-hexamethylbiphenyl-4,4′-diyl of the following formula (5). An acid dianhydride in which X in formula (3) is 2,2′,3,3′,5,5′-hexamethylbiphenyl-4,4′-diyl is represented by formula (6).

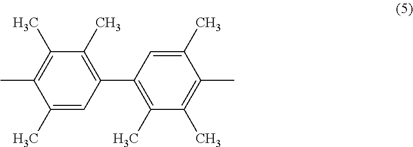

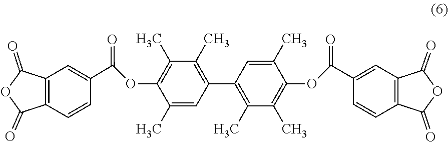 [SMILES: Cc1cc(-c2cc(C)c(OC(=O)c3ccc4c(c3)C(=O)OC4=O)c(C)c2C)c(C)c(C)c1OC(=O)c1ccc2c(c1)C(=O)OC2=O]

That is, in an embodiment, the polyimide contains a compound of formula (6): bis(1,3-dioxo-1,3-dihydroisobenzofuran-5-carboxylic acid)-2,2′,3,3′,5,5′-hexamethylbiphenyl-4,4′-diyl (abbreviation: TAHMBP) as an acid anhydride.

The amount of the acid dianhydride of general formula (3) may be 30 mol % or more based on 100 mol % of all acid dianhydride components forming the polyimide. When the ratio of the acid dianhydride of general formula (3) becomes higher, the compatibility between the polyimide and the ester-based polymer tends to be improved, leading to a decrease in haze of the film and hence improvement of transparency. The amount of the acid dianhydride of general formula (3) based on 100 mol % of all acid dianhydride components may be 40 mol % or more, 45 mol % or more, 50 mol % or more, 55 mol % or more, 60 mol % or more, 65 mol % or more, or 70 mol % or more.

From the viewpoint of improving compatibility with the ester-based polymer, the amount of the acid dianhydride of general formula (6) may be 30 mol % or more based on 100 mol % of all acid dianhydride components forming the polyimide. The amount of the acid dianhydride of formula (6) based on 100 mol % of all acid dianhydride components may be 40 mol % or more, 45 mol % or more, 50 mol % or more, 55 mol % or more, 60 mol % or more, 65 mol % or more, or 70 mol % or more. The polyimide may contain, in addition to TAHMBP, an acid dianhydride of general formula (3) other than TAHMBP as the acid dianhydride component.

If the ratio of the acid dianhydride of general formula (3) is excessively large, the birefringence of the film may increase. The amount of the acid dianhydride of general formula (3) based on 100 mol % of all acid dianhydride components may be 90 mol % or less, 85 mol % or less, 80 mol % or less, or 75 mol % or less.

As described above, the amount of the acid dianhydride of general formula (3), among the acid dianhydride components of the polyimide, may be 90 mol % or less, and it is preferable that acid dianhydrides other than the acid dianhydride of general formula (3) constitute 10 mol % or more of the acid dianhydride components.

Examples of the acid dianhydride other than the acid dianhydride of general formula (3) include ethylenetetracarboxylic dianhydride, butanetetracarboxylic dianhydride, 1,2,3,4-cyclobutanetetracarboxylic dianhydride, 1,2,3,4-cyclopentanetetracarboxylic dianhydride, 1,2,4,5-cydohexanetetracarboxylic dianhydride, 1,1′-bicyclohexane 53,3′,4,4′-tetracarboxylic acid-3,4,3′,4′-dianhydride, 3,3′,4,4′-benzophenonetetracarboxylic dianhydride, 2,2′,3,3′-benzophenonetetracarboxylic dianhydride, 2,2′,3,3′ -biphenyltetracarboxylic dianhydride, pyromellitic dianhydride, 3,3′,4,4′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenypethane dianhydride, bis(2,3 -dicarboxyphenyl)methane dianhydride, bis(3,4-dicarboxyphenyl)methane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 2,2-bis{4-[4-(1,2-dicarboxy)phenoxy]pheny}-1,1,1,3,3,3-hexafluoropropane dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy) phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 2,2-bis{4-[4-(1,2-dicarboxy)phenoxy]phenyl}-1,1,1,3,3,3-hexafluoropropane dianhydride, 2,2-bis{4-[3-(1,2-dicarboxy)phenoxy]phenyl}-1,1,1,3,3,3-propane dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenanthrenetetracarboxylic dianhydride, and bis(1,3-dihydro-1,3-dioxo-5-isobenzofuranecarboxylic acid)-1,4-phenylene ester.

From the viewpoint of improving the transparency of the polyimide and the solubility of the polyimide in an organic solvent and reducing birefringence, it is preferable that among the above-described acid anhydrides, an acid anhydride of the following formula X-1, X-2 or X-3 or an acid anhydride having an alicyclic structure is contained. M in X-3 is O, S or SO₂.

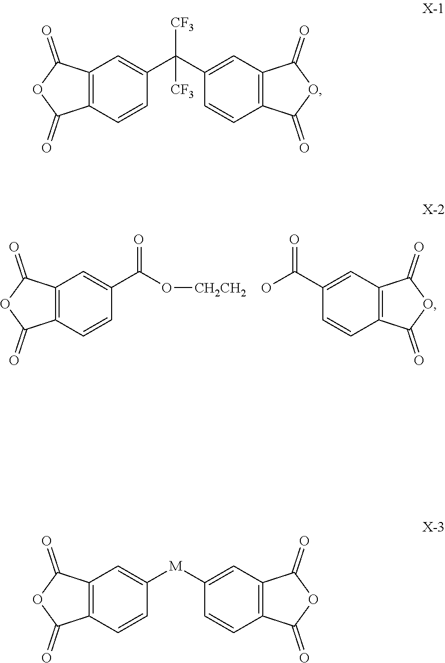

Specific examples of the alicyclic acid dianhydride include acid dianhydrides of the following group (III).

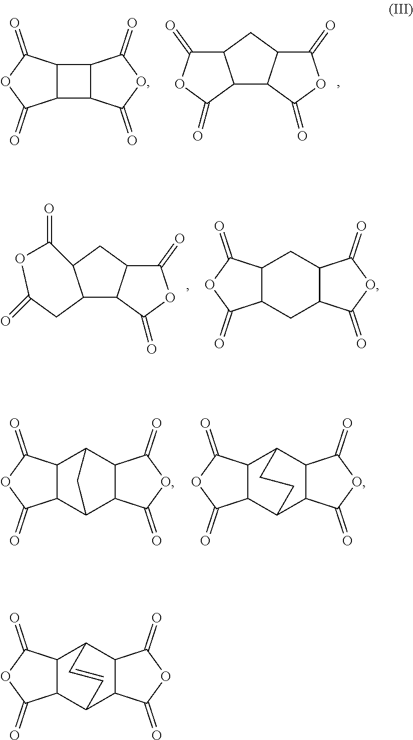

The total amount of acid anhydrides of the above X-1, X-2 and X-3 and group (III) contained as acid anhydride components in the polyimide may be 10 mol % or more, 15 mol % or more, 20 mol % or more, or 25 mol % or more.

### Diamine

The polyimide in the present embodiment contains a diamine of the following general formula (4) as a diamine component.

H₂N—Y—N H₂ (4)

Y in general formula (4) is identical to Yin general formula (1). In other words, Y is a diamine residue having one or more selected from the group consisting of a fluorine group, a trifluoromethyl group, a sulfone group, a fluorene structure and an alicyclic structure. Since the polyimide contains a diamine component having any of these functional groups, the polyimide exhibits transparency and excellent solubility in an organic solvent.

Examples of diamines represented by general formula (4), i.e., diamines containing one or more selected from the group consisting of a fluorine group, a trifluoromethyl group, a sulfone group, a fluorene structure and an alicyclic structure, include 3,3′-diaminodiphenylsulfone, 3,4′-diaminodiphenylsulfone, 4,4′-diaminodiphenyl sulfone, bis[4-(3-aminophenoxy)phenyl]sulfide, bis[4-(4-aminophenoxy)phenyl]sulfide, 4,4′-bis[4-(4-amino-α,α-dimethylbenzyl)phenoxy]diphenylsulfone, 4,4′-bis[4-(4-aminophenoxy)phenoxy]diphenylsulfone, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino-2,3,5,6-tetrafluorobenzene, 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, and 1,4-di amino-2,3,5,6-tetrakis(trifluoromethyl)benzene, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6,-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, 2,2′,3,35,5′,6,6′-octafluorobenzidine, 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoro)methyl)benzidine, 2,2′-bis(trifluoromethyl)benzidine, 3,3′-bis(trifluoromethyl)benzidine, 2,3′-bis(trifluoromethyl)benzidine, 2,2′,3-bis(tri fluoromethyl) benzidine, 2,3,3′-tris(trifluoromethyl)benzidine, 2,2′,5-tris(trifluoromethyl)benzidine, 2,2′,6-tris(trifluoromethyl))benzidine, 2,3′,5-tris(trifluoromethyl)benzidine, 2,3′,6,-tris (trifluoromethyl)benzidine, 2,2′,3,3′-tetrakis(trifluoromethyl)benzidine, 2,2′,5,5′-tetrakis(trifluoromethyl)benzidine, and 2,2′, 6,6′-tetrakis(trifluoromethyl)benzidine, 2,2-di(3-aminophenyl)-1,1,1,3,3,3-hexafluoropropane, 2,2-di(4-aminophenyl)-1,1,1,3,3,3-hexafluoropropane, 2-(3-aminophenyl)-2-(4-aminophenyl)-1,1,1,3,3,3-hexafluoropropane, 1,3-bis(3-amino-α,α-ditrifluoromethylbenzyl)benzene, 1,3-bis(4-amino-α,α-ditrifluoromethylbenzyl)benzene, 1,4-bis(3-amino-α,α-ditrifluoromethylbenzyl)benzene, 1,4-bis(4-amino-α,α-ditrifluoromethylbenzyl)benzene, bis[4-(3-aminophenoxy)phenyl]sulfone, bis[4-(4-aminophenoxy)phenyl]sulfone, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 4,4′-bis[4-(4-amino-α,α-dimethylbenzyl)phenoxy]diphenyl sulfone, 4,4′-bis[4-(4-aminophenoxy)phenoxy]diphenyl sulfone, 1,2-diaminocyclohexane, 1,3-diaminocylohexane, 1,4-diaminocyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, 2,6-bis(aminomethyl)bicyclo[2.2.1]heptane, 2,5-bis(aminomethyl)bicydo[2.2.1]heptane, 9,9′-bis(4-aminophenyl)fluorene (FDA), and 9,9′-bis(4-amino-3-fulorophenyl)fluorene (FFDA).

Among the above-described diamines, diamines of Y-1 to Y-5 are preferable from the viewpoint of reducing the birefringence of the polyimide, and a diamine of Y-6 is preferable from the viewpoint of transparency. R⁹ in Y-5 is a methyl group or hydrogen. The polyimide may contain, as the diamine component, both one or more selected from Y-1 to Y-5 and Y-6.

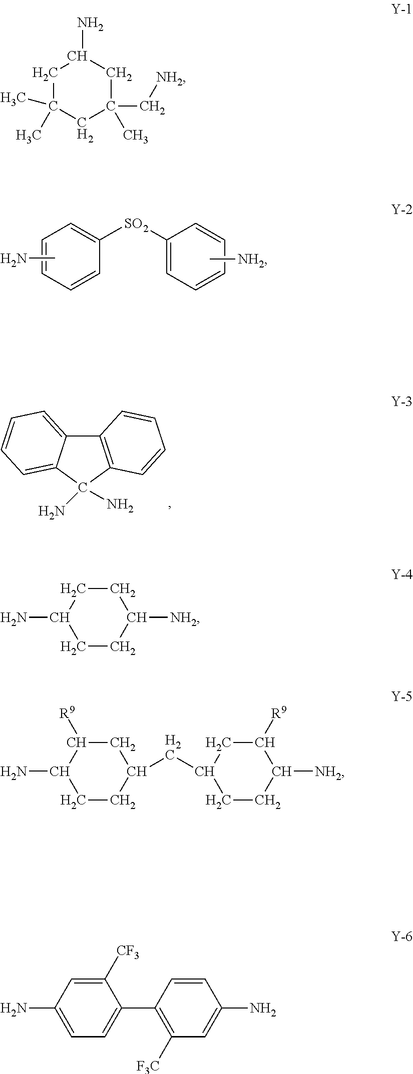

The amount of the above diamine based on 100 mol % of all diamine components may be 5 mol % or more, 10 mol % or more, 15 mol % or more, 20% or more, 30% or more, 40% or more, 50% or more, 60% or more, 70% or more, 80% or more, 90% or more, or 100%. The total amount of Y-1 to Y-6 may be in the above-mentioned range.

From the viewpoint of transparency and solubility of the polyimide, the amount of 2,2′-bis(trifluoromethyl)benzidine (Y-6) based on the total amount of the diamine components may be 5 mol % or more, or may be 10 to 99 mol %, 20 to 98 mol %, 30 to 97 mol %, 35 to 96 mol %, or 40 to 95 mol %.

A diamine which does not contain any of a fluorine group, a trifluoromethyl group, a sulfone group, a fluorene structure and an alicyclic structure may be used as long as the transparency of the polyimide and the solubility thereof in an organic solvent are not excessively deteriorated. Concrete examples of such diamines include 1,4-phenylenediamine, 1,3-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3 -bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl) benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 4,4′-bis[4-(4-aminophenoxy)phenoxy]diphenylsulfone, 3,3′-diamino-4,4 -diphenoxybenzophenone, 3,3′-diamino-4,4′-dibiphenoxybenzophenone, 3,3′-di amino-4-phenoxybenzophenone, 3,3′-diamino-4-biphenoxybenzophenone, 6,6′-bis(3-aminophenoxy)-3,3,3′,3′-tetramethyl-1,1′-spirobiindan, 6,6′-bis(4-aminophenoxy)-3,3,3′,3′-tetramethyl-1,1′-spirobiindan, 1,3-bis(3-aminopropyl)tetramethyl disiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, triethylene glycol bis(3-aminopropyl)ether, ethylenediamine, 1,3-diaminopropane, 1,4-diaminobutane, 1,5-diaminopentane, 1,6-di aminohexane, 1,7-diaminoheptane, 1,8-diaminooctane, 1,9-diaminononane, 1,10-diaminodecane, 1,11-diaminoundecane, 1,12-diaminododecane, and the like.

### Composition of Polyimide

As described above, adjustment of the composition of the polyimide, i.e. the types and ratios of the acid dianhydride and the diamine, allows the polyimide to have transparency and solubility in an organic solvent and exhibit compatibility with an ester-based polymer. A solubility parameter (SP value) can be used as one of indications of solubility of a polyimide in an organic solvent and compatibility of a polyimide with other resins.

The SP value of the polyimide is a value obtained by summing the products of the SP values and the composition ratios (molar ratios to the total amount of acid anhydrides and diamines which is defined as 1) of the monomers (acid dianhydrides and diamines) alone. Solubility and compatibility tend to be enhanced as the difference in SP value between the polyimide and the solvent and other resins becomes smaller. From the viewpoint of compatibility with the ester-based resin, the SP value of the polyimide may be 8.10 to 9.10 (cal/cm³)^{1/2}, or 8.15 to 9.00 (cal/cm³)^{1/2}.

It is preferable that the polyimide exhibits solubility in one or more solvents selected from methylene chloride, chloroform, 1,2-dichloroethane, 1,1,2,2-tetrachloroethane, N-methyl-2-pyrrolidone, chlorobenzene, dichlorobenzene, tetrahydrofuran and 1,4-dioxane. The phrase “the polyimide exhibits solubility in a solvent” means that the polyimide is dissolved at a concentration of 5 wt % or more. The polyimide may be soluble in methylene chloride, among the above-described solvents, because methylene chloride has a low boiling point, so that it is easy to remove the residual solvent during production of a film.

### Preparation of Polyimide Resin

A polyamic acid as a polyimide precursor is obtained by a reaction between an acid dianhydride and a diamine, and a polyimide is obtained by dehydration and cyclization (imidization) of the polyamic acid.

The method for preparing a polyamic acid solution is not particularly limited, and any known method can be applied. For example, the acid dianhydride and the diamine are dissolved in an organic solvent in substantially equimolar amounts (molar ratio=95:100 to 105:100), and the solution is stirred to obtain a polyamic acid solution. The concentration of the polyamic acid solution may be typically 5 to 35 wt %, or 10 to 30 wt %. When the concentration is in this range, the polyamic acid obtained by polymerization has an appropriate molecular weight, and the polyamic acid solution has an appropriate viscosity.

In polymerization of the polyamic acid, a method is preferable in which an acid dianhydride is added to a diamine for suppressing ring opening of the acid dianhydride. When a plurality of diamines and a plurality of acid dianhydrides are added, they may be added at one time, or may be added in a plurality of additions. By adjusting the order of adding the monomers, various physical properties of the polyimide can be controlled.

The organic solvent used for polymerization of the polyamic acid is not particularly limited as long as it does not react with a diamine and an acid dianhydride and can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethylsulfone; amide-based solvents such as N,N-dimethyacetamide (DMAc), N,N-dimethylformamide (DMF), N,N′-diethylacetamide, N-methyl-2-pyrrolidone (NMP), y-butyrolactone and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether and p-cresol methyl ether. These solvents are normally used singly, or if necessary, two or more thereof are used in combination as appropriate. From the viewpoint of the solubility and polymerization reactivity of the polyamic acid, DMAc, DMF, NMP and the like may be used.

A polyimide can be obtained by dehydration and cyclization of the polyamic acid. Examples of the method for preparing a polyimide from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing a polyimide generated by imidization of the polyamic acid, a polyimide resin is precipitated as a solid. By isolating the polyimide resin as a solid substance, impurities generated during synthesis of the polyamic acid, and the residual dehydration agent and the imidization catalyst and the like can be washed and removed with the poor solvent, so that it is possible to prevent coloring of the polyimide and an increase in yellowness. By isolating the polyimide resin as a solid, a solvent suitable for forming a film, such as a low-boiling-point solvent, can be applied in preparation of a solution for producing a film.

The molecular weight (weight average molecular weight in terms of polyethylene oxide which is measured by gel filtration chromatography (GPC)) of the polyimide may be 10,000 to 200,000, 20,000 to 180,000, or 40,000 to 180,000. An excessively small molecular weight may result in insufficient strength of the film. An excessively large molecular weight may result in poor compatibility with the ester-based resin.

### Ester-Based Resin

The ester-based resin in the present embodiment is polycarbonate or a polyarylate, and contains a structural unit of the above general formula (2).

### Polycarbonate

Polycarbonate is a carbonic acid ester of bisphenol and has a repeating unit of general formula (7).

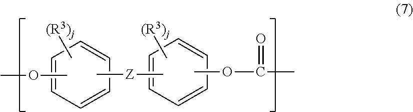

Z, R³ and j in general formula (7) are identical, respectively, to Z, R³ and j in general formula (2).

From the viewpoint of solubility in an organic solvent and compatibility with the polyimide, the polycarbonate may be one in which the divalent organic group Z is an isopropylidene group and j is 0, i.e. a carbonic acid ester of bisphenol A which has a repeating unit of formula (8).

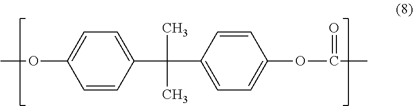

Examples of the commercially available product of polycarbonate containing a repeating unit of formula (8) include Panlites AD-5503, K-1300Y, L-1225L, L-1225LM, L-1225Y, L-1225Z100, L-1225Z100M, L-1225ZL100, L-1250Y, L-1250Z100, LD-1000RM, LN-10 1 ORM, LN-2250Y, LN-2250Z, LN-2520A, LN-2520HA, LN-2525ZA, LN-3000RM, LN-3050RM, LS-2250, LV-2225L, LV-2225Y, LV-2225Z, LV-2250Y, LV-2250Z, MN-4800, MN-4800Z and MN-4805Z manufactured by 1EITIN LIMITED; and Iupilons K 4100, ML 200, ML 300 and ML 400 manufactured by Mitsubishi Engineering-Plastics Corporation.

The polycarbonate may contain a bisphenol component other than bisphenol A. Specific examples of the bisphenol include 1,2-bis(4-hydroxyphenyl)ethane, 2-(4-hydroxyphenyl)-2-(3-hydroxyphenyl)propane, 1,2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4 hydroxyphenyl)propane, 2,2-bis(3-methoxy-4-hydroxyphenyl)propane, bis(4-hydroxyphenyl)ether, bis(4-hydroxyphenyl)sulfide, bis(4-hydroxyphenyl)sulfoxide, bis(4-hydroxyphenyl)sulfone, 1,6-dihydroxynaphthalene, 2,6-dihydroxynaphthalene, 6,6′-dihydroxy-3,3,3′,3′-tetramethylspiro(bis)indane, 2,6-dihydroxydibenzo-p-dioxine, 2,6-dihydroxyanthrene, 2,7-dihydroxyphenoxatin, 2,7-dihydroxy-9,10-dimethylphenazine, 3,6-dihydroxybenzofuran, 3,6-dihydroxyanthrene, tert-butylhydroquinone, 2,5-di-tert-butylhydroquinone, 2,5-di-tert-amylhydroquinone, 2,2′-dimethylbiphenyl-4,4′-diol, 3,3′-dimethylbiphenyl-4,4′-diol, isopropylidenediphenol, 3,3′,5,5′-tetramethylbiphenyl-4,4′-diol, 2,2′,3,3′,5,5′-hexamethylbiphenyl-4,4′-diol, and resorcinol.

The divalent organic group Z in formula (7) may contain a cyclic structure. Examples of the cyclic structure include aromatic backbones such as fluorene backbones and phthalimide backbones; and alicyclic backbones such as cyclohexylmethylidene, 2-[2.2.1]-bicycloheptylidene, cyclohexylidene, cyclopentylidene, cyclododecylidene and adamantylidene. Specific examples of the bisphenol in which Z has a cyclic structure include 9,9-bis(4-hydroxyphenyl)fluorene, 9,9-bis[4-(2-hydroxyethoxy)phenyl]fluorene, 9,9-bis(4-hydroxy-3-methylphenyl)fluorene, 3,3-bis(4-hydroxyphenyl)phthalimidine, 2-phenyl-3,3-bis(4-hydroxyphenyl)phthalimidine, and 1,1-bis(4-hydroxy-3-methylphenyl)cyclohexane.

From the viewpoint of the strength of the film and compatibility with the polyimide, the weight average molecular weight (in terms of polystyrene) of the polycarbonate may be 5,000 to 250,000, 10,000 to 200,000, or 15,000 to 150,000.

### Polyarylate

The polyarylate is an ester of bisphenol and phthalic acid (terephthalic acid and/or isophthalic acid), and has a repeating unit of general formula (9).

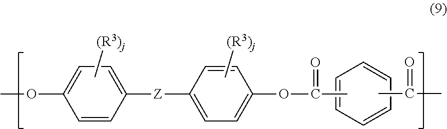

Z, R³ and j in general formula (9) are identical, respectively, to Z, R³ and j in general formula (2).

The ratio between the isophthalic acid-derived structure and the terephthalic acid-derived structure in the polyarylate is not particularly limited, and is 0:100 to 100:0. From the viewpoint of solubility in a solvent and compatibility with the polyimide, the ratio of isophthalic acid to terephthalic acid may be 2:98 to 98:2, 5:95 to 95:5 or 10:90 to 90:10.

From the viewpoint of solubility in an organic solvent and compatibility with the polyimide, the polyarylate may be one in which the divalent organic group Z is an isopropylidene group and j is 0, i.e. an ester of bisphenol A and phthalic acid which has a repeating unit of formula (10).

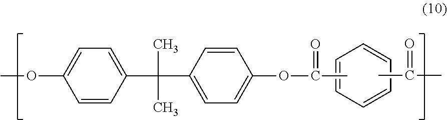

Examples of commercially available products of the polyarylate containing a repeating unit of formula (10) include U-100 and T-200 manufactured by UNITIKA LTD. As commercially available products of the polyarylate, U-8000, U-8400 H, FUN-8000, C 300 VN, P-1001, P-3001, P-5001, P-1001 A, P-3001 S, P-5001 S and the like manufactured by UNITIKA LTD. may be used.

The polyarylate may contain a bisphenol component other than bisphenol A. Specific examples of the bisphenol other than bisphenol A include those described above as the bisphenol component of polycarbonate.

From the viewpoint of the strength of the film and compatibility with the polyimide, the weight average molecular weight (in terms of polystyrene) of the polyarylate may be 5,000 to 150,000, 10,000 to 130,000, or 15,000 to 100,000.

### Preparation of Resin Composition

The polyimide resin and the ester-based resin are mixed to prepare a resin composition. The resin composition may contain both the polycarbonate and the polyarylate as the ester-based resin.

Since the polyimide resin and the ester-based resin at an arbitrary ratio can be compatible with each other, the ratio of the polyimide resin to the ester-based resin in the resin composition is not particularly limited. The mixing ratio (weight ratio) of the polyimide resin to the ester-based resin may be 98:2 to 2:98, 95:5 to 10:90, or 90:10 to 15:85. When the ratio of the polyimide resin is high, the elastic modulus of the film tends to increase, resulting in excellent mechanical strength. The birefringence (particularly birefringence in a thickness direction) of the film tends to decrease as the ratio of the ester-based resin increases.

The polyimide is a polymer having a special molecular structure, and generally has low solubility in an organic solvent and is not compatible with other polymers. In the present embodiment, the polyimide exhibits high solubility in an organic solvent and is compatible with the polycarbonate and polyarylate because the polyimide contains a bis(trimellitic anhydride) ester of general formula (3) as an acid anhydride component and has a structural unit of general formula (1). One of the reasons why the polyimide shows compatibility with the polycarbonate and polyarylate is that the structures of phenol esters in general formulae (1) and (3) are highly similar to the structures of bisphenol esters in the polycarbonate and polyarylate.

In order to be compatible with the polycarbonate, the polyimide may contain the acid dianhydride of general formula (3) at 50 mol % or more, 60 mol % or more, or 65 mol % or more, based on 100 mol % of all acid dianhydride components. In particular, the acid dianhydride of formula (6) may be contained at 50 mol % or more, 60 mol % or more, or 65 mol % or more.

In order to be compatible with the polyarylate, the polyimide may contain the acid dianhydride of general formula (3) at 30 mol % or more, 40 mol % or more, or 45 mol % or more, based on 100 mol % of all acid dianhydride components. In particular, the acid dianhydride of formula (6) may be contained at 30 mol % or more, 40 mol % or more, or 45 mol % or more.

The resin composition may be a mixed solution containing a polyimide resin and an ester-based resin. The method for mixing the resins is not particularly limited, and the resins may be mixed in a solid state, or may be mixed in a liquid to form a mixed solution. The polyimide resin solution and the ester-based resin solution may be individually prepared, and mixed to prepare a mixed solution of the polyimide resin and the ester-based resin.

The solvent of the solution containing the polyimide resin and the ester-based resin is not particularly limited as long as it exhibits an ability to dissolve both the polyimide resin and the ester-based resin. Examples of the solvent include N,N-dimethylformamide, N,N-dimethylacetamide, N-methylpyrrolidone, chloroform, 1,2-dichloroethane, 1,1,2,2-tetrachloroethane, N-methyl-2-pyrrolidone, chlorobenzene, dichlorobenzene, tetrahydrofuran, 1,4-dioxane and methylene chloride. Methylene chloride is particularly preferable as the solvent because it is excellent in compatibility with the polyimide resin and the ester-based resin, and has a low boiling point, so that it is easy to remove the residual solvent during production of a film.

For the purpose of, for example, improving the processability of the film and imparting various functions, an organic or inorganic low-molecular-weight or high-molecular-weight compound may be blended in the resin composition (solution). The resin composition may contain a flame retardant, an ultraviolet absorber, a crosslinking agent, a dye, a pigment, a surfactant, a leveling agent, a plasticizer, fine particles, a sensitizer and the like. The fine particles include organic fine particles such as those of polystyrene and polytetrafluoroethylene, and inorganic fine particles such as those of colloidal silica, carbon and layered silicate, and may have a porous or hollow structure.

### Film

A solution containing the polyimide resin and the ester-based resin is applied onto a support, and the solvent is removed by drying to obtain a film.

As a method for applying the resin solution onto the support, a known method using a bar coater, a comma coater or the like can be applied. As the support, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a continuous length plastic film or the like as the support. When a plastic film is used as the support, a material that is not soluble in a deposition dope solvent may be appropriately selected, and as the plastic material, polyethylene terephthalate, polycarbonate, polyacrylate, polyethylene naphthalate or the like is used.

It is preferable to perform heating the solvent during drying. The heating temperature is not particularly limited as long as the solvent can be removed and coloring of the resulting film can be suppressed, and the temperature is appropriately set to room temperature to about 250° C., and may be 50° C. to 220° C. When the temperature is in this range, coloring of the film can be suppressed, and the retardation (birefringence) in the thickness direction of the film can be reduced. The heating temperature may be elevated stepwise. After drying proceeds to some extent, the resin film may be peeled off from the support and dried for enhancing the solvent removal efficiency. For accelerating the removal of the solvent, heating may be performed under reduced pressure.

The thickness of the film is not particularly limited, and may be appropriately set according to a use purpose. The thickness of the film is, for example, 5 to 300 μm. From the viewpoint of achieving both self-supporting properties and flexibility and obtaining a film having high transparency, the thickness of the film may be 20 μm to 100 μm, 30 μm to 90 μ, 40 μm to 85 μm, or 50 μm to 80 μm. The thickness of the film which is used as a cover film for a display may be 50 μm or more.

The haze of the film may be 5% or less, 4% or less, 3.5% or less, 3% or less, 2% or less, or 1% or less. The haze of the film may be as low as possible. Since the polyimide resin and the ester-based resin are compatible with each other, a film having a low haze and high transparency is obtained. The haze of the film tends to decrease as the ratio of the acid dianhydride of general formula (3), among the acid anhydride components of the polyimide, becomes higher, and in particular, the haze of the film tends to decrease as the ratio of the acid anhydride of formula (6) becomes higher.

The yellowness index (YI) of the film may be 5.0 or less. Since a polyimide having the structural unit of general formula (1) absorbs a less amount of visible light as described above, a film having high transparency and small YI is obtained.

The thickness-direction retardation Rth of the film may be 3000 nm or less from the viewpoint of suppressing a decrease in visibility due to coloring of a screen or the like. From the viewpoint of strength, the tensile modulus of the film may be 3.0 GPa or more. Since the polyimide resin and the ester-based resin are compatible with each other, the Rth and the tensile modulus are values intermediate between a film of the polyimide resin alone and a film of the ester-based resin alone, and by adjusting the blending ratio of both the resins, a film having both the Rth and the tensile modulus is obtained.

### EXAMPLES

Hereinafter, one or more embodiments of the present invention will be described in further detail on the basis of examples and comparative examples. One or more embodiments of the present invention are not limited to examples below.

### Polyimide Resin Production Examples

Dimethylformamide was added into a separable flask, and stirred in a nitrogen atmosphere. To this was added a diamine and an acid dianhydride at a ratio (%) as shown in Table 2, and the mixture was reacted by stirring in a nitrogen atmosphere for 5 to 10 hours to obtain a polyamic acid solution having a solid content concentration of 18 wt %. In Production Examples 1A to 1C, Production Examples 3A and 3B, Production Examples 4A and 4B, Production Examples 6A and 6B and Production Examples 11A and 11B, the molecular weight was adjusted by changing the reaction time.

To 100 g of the polyamic acid solution, 5.5 g of pyridine as an imidization catalyst was added, and completely dispersed, 8 g of acetic anhydride was then added, and the mixture was stirred at 90° C. for 3 hours. The solution was cooled to room temperature, and 100 g of 2-propyl alcohol (hereinafter, referred to as “IPA”) was then added dropwise at a rate of 2 to 3 drops/sec while the solution was stirred, thereby precipitating a polyimide. Further, 150 g of IPA was added, the mixture was stirred for about 30 minutes, and suction filtration was performed with a Kiriyama funnel. The obtained solid was washed with IPA, and then dried in a vacuum oven set at 120° C. for 12 hours to obtain a polyimide resin.

### Film Production Examples

### Films 1 to 14

The polyimide (PI) obtained in the production example above and a commercially available polyarylate (PAR) were mixed with methylene chloride at a ratio as shown in Table 3, thereby preparing a methylene chloride solution having a resin content of 11 wt %. This solution was applied onto an alkali-free glass plate, and dried by heating at 40° C. for 60 minutes, 70° C. for 30 minutes, 150° C. for 30 minutes, 170° C. for 30 minutes and 200° C. for 60 minutes in an air atmosphere to produce Films 1 to 14 having a thickness of about 50 μm.

### Films 21 to 28

The polyimide (PI) obtained in the production example above and a commercially available polycarbonate (PC) were mixed with methylene chloride at a ratio as shown in Table 4, thereby preparing a methylene chloride solution having a resin content of 11 wt %. This solution was applied and dried under the same conditions as in the preparation of Films 1 to 14 described above, thereby producing Films 21 to 28 having a thickness of about 50 μm.

### Reference Examples A to D

In Reference Examples A and C, a methylene chloride solution of a polyimide resin was prepared, and a film having a thickness of about 50 μm was produced under the same conditions as described above. In Reference Example B, a methylene chloride solution of a polyarylate was prepared, and a film having a thickness of about 50 μm was produced under the same conditions as described above. In Reference Example D, a methylene chloride solution of polycarbonate was prepared, and applied and dried under the same conditions as described above, thereby producing a film having a thickness of about 50 μm.

### Evaluation Methods

### Evaluation of Polyimide Resin

### Solubility in Methylene Chloride

To the polyimide resin was added methylene chloride to a solid content concentration of 10 wt %, and the mixture was stirred at room temperature for 12 hours, followed by visual examination of the solution. The polyimide resins of all production examples were free of an insoluble substance, and had solubility in methylene chloride.

### Molecular Weight

The polyimide was dissolved in the eluent to have a concentration of 0.04 wt %, and analysis with GPC was performed under the conditions shown in Table 1 to obtain weight average molecular weight (Mw).

TABLE 1

| Item | Condition |
|---|---|
| Apparatus | Column oven: CO-8020 |
| | Degasser: SD-8022 |
| | Pump: DP-8020 |
| | Detector: RI-8020 |
| | Auto sampler: AS-8020 |
| | (each manufactured by Tosho Corporation) |
| Column | Shodex GPC KD-806M × 2, each having 8 mmφ × 30 cm, |
| | total 60 cm |
| uard column | Shodex GPC KD-G, 4.6 mmφ × 1 cm |
| Column temperature | 40° C. |
| Eluent | 30 mM-LiBr + 30 mM-phosphoric acid/DMF |
| | Flow rate: 0.6 mL/min |
| Injection pressure | About 1.3 to 1.7 MPa |
| Injection volume | 30 μL (solid content concentration of 0.4 wt %) |
| Standard sample | Polyethylene oxide (used for preparation of calibration curve) |
| Detector | RI |
| Order of calibration curve | One dimension |

### Evaluation of Film

### Haze

The film was cut to a 3 cm square, and measured in accordance with JIS K 7136 using a haze meter “HZ-V3” manufactured by Suga Test Instruments Co., Ltd. For those having a haze of more than 20%, measurements of the yellowness index, the tensile modulus and the thickness-direction retardation below were not performed (indicated as ND in Tables 3 and 4).

### Yellowness Index

The film was cut to a 3 cm square, and the yellowness index (YI) was measured in accordance with JIS K 7373 using a spectrophotometer “SC-P” manufactured by Suga Test Instruments Co., Ltd.

### Tensile Modulus

The film was cut into a strip shape having a width of 10 mm, and the tensile modulus was measured using “AUTOGRAPH AGS-X” manufactured by Shimadzu Corporation under the following conditions: distance between grippers: 100 mm, and tensile speed: 20.0 mm/min.

### Thickness-Direction Retardation

The film was cut to a 3 cm square, and the in-plane retardation and the oblique direction retardation at a wavelength of 590 nm were measured using a retardation measuring apparatus “KOBRA” manufactured by Oji Scientific Instruments, and the thickness-direction retardation Rth was calculated with an average refractive index of 1.60.

### Evaluation Results

Table 2 shows the compositions of the diamine and the acid dianhydride and the SP value and the weight average molecular weight (Mw) of the polyimide in the production examples of the polyimide. The unit of the SP value in Table 2 is (cal/cm³)^{1/2}, and the SP value of the polyimide is a value obtained by adding the products of the SP values of the monomers and the molar ratios to the total amount of the diamine and the acid dianhydride.

In Table 2, the compounds are represented by the following abbreviations.

### Diamine

TFMB: 2,2′-bis(trifluoromethyl)benzidine

3,3′-DDS: 3,3′-diaminodiphenylsulfone

### Acid Dianhydride

TAHMBP: bis(1,3-dioxo-1,3-dihydroisobenzofuran-5-carboxylic acid)-2,2′,3,3′,5,5′-hexamethylbiphenyl-4,4′-diyl

OCBP-TME: bis(1,3-dioxo-1,3-dihydroisobenzofuran-5-carboxylic acid)-3,3′-dimethylbiphenyl-4,4′-diyl

BP-TME: bis(1,3-dioxo-1,3-dihydroisobenzofuran-5-carboxylic acid)biphenyl-4,4′-diyl

Bis-DA2000: 4,4′-(4,4′-isopropylidenediphenoxy)diphthalic dianhydride

TMEIQ: p-phenylene bis(trimellitic acid monoester acid anhydride)

s-BPDA: 3,3′,4,4′-biphenyltetracarboxylic acid dianhydride

α-BPDA: diphenyl-2,3,3′,4′-tetracarboxylic dianhydride

CBDA: 1,2,3,4-cydobutanetetracarboxylic acid dianhydride

6FDA: 2,2-bis(3,4-dicarboxyphenyl)-1,1,1,3,3,3-hexafluoropropane dianhydride

TABLE 2

| | Composition (mol %) | | | | | | | | | | | | | |
|---|---|---|---|---|---|---|---|---|---|---|---|---|---|---|
| Pro- | | Diamine | | Acid dianhydride | | | | | | | | | | |
| duction | Mono- | | 3, 3′- | TAH | OCBP- | BP- | Bis- | | | | | | | |
| Ex- | mer | TFMB | DDS | MBP | TME | TME | DA2000 | TMHQ | s-BPDA | α-BPDA | CBDA | 6FDA | Polyimide | |
| ample | SP | 7.96 | 10.22 | 8.14 | 8.74 | 8.93 | 8.10 | 9.56 | 10.83 | 10.79 | 13.33 | 8.21 | SP | Mw |

| | | | | | | | | | | | | | |
|---|---|---|---|---|---|---|---|---|---|---|---|---|---|
| 1A | 90 | 10 | 50 | — | — | — | — | 15 | — | 15 | 20 | 8.76 | 69500 |
| 1B | | | | | | | | | | | | | 110000 |
| 1C | | | | | | | | | | | | | 140000 |
| 2 | 90 | 10 | 45 | — | — | — | — | — | 10 | 25 | 20 | 8.95 | 58000 |
| 3A | 90 | 10 | 50 | — | — | 15 | — | — | — | 15 | 20 | 8.56 | 96900 |
| 3B | | | | | | | | | | | | | 146000 |
| 4A | 90 | 10 | 50 | — | — | 15 | — | 15 | — | — | 20 | 8.37 | 82300 |
| 4B | | | | | | | | | | | | | 105000 |
| 5 | 90 | 10 | 50 | — | — | 30 | — | — | — | — | 20 | 8.16 | 121000 |
| 6A | 90 | 10 | 50 | — | — | 20 | 0 | 15 | — | 15 | — | 8.75 | 86000 |
| 6B | | | | | | | | | | | | | 101000 |
| 7 | 90 | 10 | 40 | — | 10 | 0 | 0 | 15 | — | 15 | 20 | 8.80 | 103000 |
| 8 | 90 | 10 | 40 | 10 | — | — | — | 15 | — | 15 | 20 | 8.79 | 116000 |
| 9 | 90 | 10 | 40 | — | — | — | — | — | — | — | 60 | 8.18 | 80100 |
| 10 | 90 | 10 | 70 | — | — | — | — | — | — | — | 30 | 8.17 | 150000 |
| 11A | 70 | 30 | — | — | — | — | 25 | 25 | — | — | 50 | 8.92 | 87500 |
| 11B | | | | | | | | | | | | | 99500 |
| 12 | 100 | — | — | — | — | — | — | — | — | 40 | 60 | 9.11 | 95600 |
| 13 | 100 | — | — | — | — | — | — | — | — | — | 100 | 8.09 | 88500 |

Table 3 shows the resin compositions and film characteristics of Films 1 to 14 (compositions of polyimides and polyarylates) produced in the film production examples, and Table 4 shows the resin compositions and film characteristics of the Films 21 to 28 (compositions of polyimides and polycarbonate). Table 3 also shows the results of Reference Examples A and B, and Table 4 also shows the results of Reference Examples C and D.

Among the acid dianhydride components of the polyimide (PI), those corresponding to the polyimide of general formula (3) are selected, and shown in Tables 3 and 4. The number given in parentheses is the ratio (mol %) of the relevant acid dianhydride to the total amount of acid dianhydride components.

The polyarylates (PAR) in Table 3 and the polycarbonate (PC) in Table 4 are as follows. Mw is a weight average molecular weight in terms of polystyrene which is measured by GPC.

PAR1: “U-100 D Series” (Mw=71,000) manufactured by UNITIKA LTD.

PAR2: “U-100 L Series” (Mw=45,600) manufactured by UNITIKA LTD.

PC1: “Iupilon K 4100” (Mw=38,400) manufactured by Mitsubishi Engineering-Plastics Corporation

PC2: “Panlite L-1225 LM” (Mw=42,000) manufactured by Teij in Ltd.

TABLE 3

| | PI | | | | | | Film properties | | | |
|---|---|---|---|---|---|---|---|---|---|---|
| | | Acid | | | | PI/PAR | | | Tensile | |
| | | dianhydride of | | PAR | | (weight | Haze | | modulus | Rth |
| Film | | formula (3) | Mw | | Mw | ratio) | (%) | YI | (GPa) | (nm) |
| 1 | 1A | TAHMBP(50) | 69500 | PAR1 | 71000 | 80/20 | 0.32 | 2.3 | 4.4 | 2870 |
| 2 | 1B | TAHMBP(50) | 110000 | PAR1 | 71000 | 50/50 | 0.35 | 1.6 | 3.4 | 1958 |
| 3 | 10 | TAHMBP(50) | 140000 | PAR1 | 71000 | 50/50 | 0.34 | 1.6 | 3.4 | 1960 |
| 4 | 2 | TAHMBP(45) | 58000 | PAR2 | 45600 | 80/20 | 1.40 | 2.1 | 3.1 | 2760 |
| 5 | 3A | TAHMBP(50) | 96900 | PAR1 | 71000 | 50/50 | 0.45 | 1.6 | 3.2 | 2161 |
| | | Bis-DA2000(15) | | | | | | | | |
| 6 | 4A | TAHMBP(50) | 82300 | PAR1 | 71000 | 50/50 | 0.60 | 1.6 | 3.1 | 1814 |
| | | Bis-DA2000(15) | | | | | | | | |
| 7 | 6A | TAHMBP(50) | 86000 | PAR1 | 71000 | 50/50 | 0.50 | 1.5 | 3.1 | 1650 |
| | | Bis-DA2000(20) | | | | | | | | |
| 8 | 7 | TAHMBP(40) | 103000 | PAR2 | 45600 | 80/20 | 3.14 | 4.6 | 3.3 | 2912 |
| | | BP-TME(10) | | | | | | | | |
| 9 | 8 | TAHMBP(40) | 116000 | PAR2 | 45600 | 80/20 | 3.34 | 5.0 | 3.5 | 2850 |
| | | OCBP-TME(10) | | | | | | | | |
| 10 | 9 | TAHMBP(40) | 80100 | PAR2 | 45600 | 80/20 | 3.35 | 2.4 | 4.1 | 2601 |
| 11 | 11A | — | 87500 | PAR2 | 45600 | 80/20 | 41.2 | ND | ND | ND |
| 12 | 12 | — | 95600 | PAR2 | 45600 | 80/20 | 40.0 | ND | ND | ND |
| 13 | 13 | — | 88500 | PAR2 | 45600 | 80/20 | 40.5 | ND | ND | ND |
| 14 | 13 | — | 88500 | PAR2 | 45600 | 50/50 | 78.8 | ND | ND | ND |
| Reference | 1A | TAHMBP(50) | 69500 | | | 100/0 | 0.40 | 2.6 | 5.0 | 3900 |
| Example A | | | | | | | | | | |

| | | | | | | | | |
|---|---|---|---|---|---|---|---|---|
| Reference | — | PAR1 | 71000 | 0/100 | 0.62 | 0.9 | 1.9 | 600 |
| Example B | | | | | | | | |

TABLE 4

| | PI | | | | | | Film properties | | | |
|---|---|---|---|---|---|---|---|---|---|---|
| | | Acid | | | | PI/PC | | | Tensile | |
| | | dianhydride | | PC | | (weight | Haze | | modulus | Rth |
| Film | | of formula (3) | Mw | | Mw | ratio) | (%) | YI | (GPa) | (nm) |
| 21 | 10 | TAHMBP(70) | 150000 | PC1 | 38400 | 80/20 | 0.54 | 1.7 | 4.4 | 2400 |
| 22 | 3B | TAHMBP(50) | 146000 | PC2 | 42000 | 80/20 | 5.56 | 3.9 | 4.6 | 2532 |
| | | Bis-DA2000(15) | | | | | | | | |
| 23 | 4B | TAHMBP(50) | 105000 | PC2 | 42000 | 80/20 | 17.8 | 4.4 | 4.7 | 2467 |
| | | Bis-DA2000(15) | | | | | | | | |
| 24 | 5 | TAHMBP(50) | 121000 | PC2 | 42000 | 80/20 | 4.78 | 3.7 | 4.4 | 2350 |
| | | Bis-DA2000(30) | | | | | | | | |
| 25 | 6B | TAHMBP(50) | 101000 | PC2 | 42000 | 80/20 | 36.8 | ND | ND | ND |
| | | Bis-DA2000(20) | | | | | | | | |
| 26 | 12 | — | 95600 | PC1 | 38400 | 50/50 | 50.2 | ND | ND | ND |
| 27 | 13 | — | 88500 | PC1 | 38400 | 50/50 | 48.2 | ND | ND | ND |
| 28 | 11B | — | 99550 | PC2 | 42000 | 80/20 | 41.5 | ND | ND | ND |
| Reference | 10 | TAHMBP(70) | 150000 | — | — | 100/0 | 0.40 | 2.6 | 5.0 | 3250 |
| Example C | | | | | | | | | | |

| | | | | | | | | |
|---|---|---|---|---|---|---|---|---|
| Reference | — | PC1 | 38400 | 0/100 | 0.62 | 0.9 | 2.1 | 47 |
| Example D | | | | | | | | |

The polyimide film of Reference Example A produced using only polyimide 1A and the polyimide film of Reference Example B produced using only polyimide 10 had a small haze, excellent transparency and a high tensile modulus, but had a large Rth. The polyarylate film of Reference Example B prepared using only a polyarylate and the polycarbonate film of Reference Example D prepared using only polycarbonate had excellent transparency and a small Rth, but had a tensile modulus of about 2 GPa, and were not sufficient in mechanical strength.

As shown in Table 3, the Films 1 to 10, which were prepared with using a composition of a polyarylate and a polyimide containing a bis(trimellitic anhydride) ester of general formula (3) such as TAHMBP as an acid dianhydride component, exhibited high transparency, and tensile modulus and Rth values intermediate between the polyimide and the polyarylate.

Comparison of the Film 1 with the Film 2 shows that the tensile modulus tends to increase as the ratio of the polyimide becomes higher, and the Rth tends to decrease as the ratio of the polyarylate becomes higher. From the comparison of the Film 2 with the Film 3, it is considered that the difference in molecular weight of the polyimide does not have a significant effect on the haze, the tensile modulus and the Rth.

The Films 11 to 14, which were prepared with using a composition of a polyarylate and a polyimide free of a bis(trimellitic anhydride) ester of general formula (3) as an acid dianhydride component, exhibited a high haze and was poor in usefulness for optics applications. Since a transparent film is obtained from each of the polyimide resins and polyarylates used for producing these films, poor compatibility of resins may be a cause of cloudiness.

These results show that the polyarylate and the polyimide containing the bis(trimellitic anhydride) ester of general formula (3) are compatible with each other, so that it is possible to produce a film having high transparency, and by adjusting the mixing ratio of the former to the latter, a film having both a high tensile modulus and a low Rth can be produced.

The Film 4 in which the polyimide 2 having TAHMBP in an amount of 45 mol % based on the total amount of acid dianhydrides and were mixed at a weight ratio of 80:20 maintained transparency, but had a haze higher than that of the Film 1. The Film 10 in which the polyimide 9 having TAHMBP in an amount of 40 mol % based on the total amount of acid dianhydrides and a polyarylate were mixed at a weight ratio of 80:20 had a further high haze. These results show that the higher the ratio of TAHMBP in the acid dianhydride component of the polyimide, the better the compatibility with the polyarylate.

The Film 5 in which the polyimide 3A containing, as acid anhydrides, TAHMBP at 50 mol % and Bis-DA 2000 that is an ester of bisphenol A and trimellitic anhydride were mixed with a polyarylate had a haze as low as that of each of the Films 1 to 3. The same applies to the Films 6 and 7.

The Film 8 in which the polyimide 7 containing, as acid anhydrides, TAHMBP at 40 mol % and BP-TME that is an ester of biphenol and trimellitic anhydride were mixed with a polyarylate had a haze of about 3% like the Film 10. The same applies to the Film 9 prepared using the polyimide 8 containing OCBP-TME as an acid dianhydride component.

The above results show that, among the compounds of general formula (3), TAHMBP containing a biphenyl backbone having three substituents on each benzene ring makes a particularly large contribution to improvement of compatibility with a polyarylate.

As shown in Table 4, the Film 21, which was prepared with using a composition of polycarbonate and a polyimide containing a bis(trimellitic anhydride) ester of general formula (3) such as TAHMBP as an acid dianhydride component, exhibited high transparency, and tensile modulus and Rth values intermediate between the polyimide and the polycarbonate.

The Films 26 to 28, which were prepared with using a composition of polycarbonate and a polyimide free of a bis(trimellitic anhydride) ester of general formula (3) as an acid dianhydride component, exhibited a high haze and was poor in usefulness for optics applications. Since a transparent film was obtained from each of the polyimide resins and polycarbonate used for producing these films, poor compatibility of resins may be a cause of cloudiness.

The Films 22 to 25, which were prepared with using a composition of polycarbonate and a polyimide containing TAHMBP at 50 mol % and Bis-DA 2000 had a lower haze as compared to the Films 26 to 28, but had a higher haze as compared to the Film 21. These results show that TAHMBP as an acid dianhydride of the polyimide also made a large contribution to improvement of compatibility when the polyimide was mixed with polycarbonate.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A resin composition comprising:
a polyimide resin; and
an ester-based resin,
wherein:
the ester-based resin is a polycarbonate or a polyarylate,
the polyimide resin is a polyimide containing a structural unit represented by general formula (1), which is obtainable by a reaction of an acid dianhydride represented by general formula (3) and a diamine represented by general formula (4): 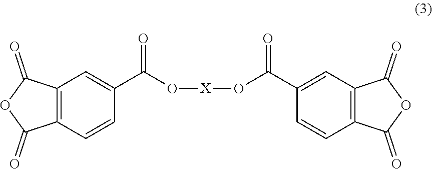
H₂N—Y—N₂ (4) 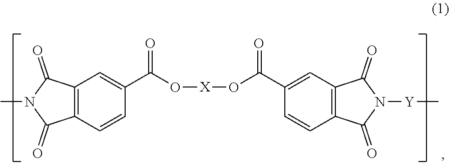
wherein a content of a tetracarboxylic acid dianhydride represented by general formula (3) is 30 mol % or more based on a total amount of acid dianhydride components of the polyimide,
where X in general formulae (1) and (3) is a divalent organic group selected from group (I) 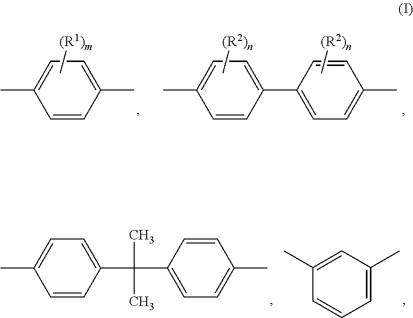
wherein each of R¹ and R² is a fluorine atom, an alkyl group having 1 to 20 carbon atoms, or a fluoroalkyl group having 1 to 20 carbon atoms; m is an integer of 1 to 4; and n is an integer of 0 to 4,
Y in general formulae (1) and (4) is a divalent group containing one or more selected from the group consisting of a fluorine group, a trifluoromethyl group, a sulfone group, a fluorene structure and an alicyclic structure.

2. The resin composition according to claim 1, wherein the polyimide resin includes an acid dianhydride of formula (6) at 30 mol % or more based on the total amount of the acid dianhydride components

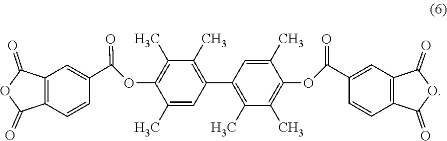 [SMILES: Cc1cc(-c2cc(C)c(OC(=O)c3ccc4c(c3)C(=O)OC4=O)c(C)c2C)c(C)c(C)c1OC(=O)c1ccc2c(c1)C(=O)OC2=O]

3. The resin composition according to claim 1, wherein the polyimide resin is soluble in methylene chloride.

4. The resin composition according to claim 1, wherein the ester-based resin is polycarbonate.

5. The resin composition according to claim 4, wherein the polycarbonate contains a repeating unit of formula (8):

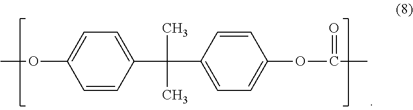

6. The resin composition according to claim 1, wherein the ester-based resin is polyarylate.

7. The resin composition according to claim 6, wherein the polyarylate contains a repeating unit of formula (10):

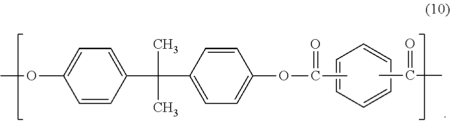

8. The resin composition according to claim 1, containing the polyimide resin and the ester-based resin at a weight ratio of 98:2 to 2:98.

9. The resin composition according to claim 1, wherein the polyimide resin has a solubility parameter of 8.10 to 9.10 (cal/cm³)^{1/2}.

10. A film comprising the resin composition set forth in claim 1.

11. The film according to claim 10, having a thickness of 5 μm or more and 300 μm or less, a haze of 3.5% or less, an YI of 5.0 or less, a thickness retardation Rth of 3000 nm or less, and a tensile modulus of 3.0 GPa or more.
